(19) United States
(12) Patent Application Publication
(10) Pub. No.: US 2017/0264177 A1
(43) Pub. Date: Sep. 14, 2017

(54) BLDC MOTOR ASSEMBLY

(71) Applicant: Hyundai Motor Company, Seoul (KR)

(72) Inventors: Sang Yeop Lee, Gunsan-si (KR); Jae Won Heo, Seoul (KR); June Kyu Park, Hwaseong-si (KR); Jong Sik Bae, Suwon-si (KR); Dong Won Yeon, Hwaseong-si (KR); Byung Guk An, Asan-si (KR); Yeong ll Ahn, Hwaseong-si (KR); Ki Youb Nam, Seoul (KR)

(73) Assignee: Hyundai Motor Company, Seoul (KR)

(21) Appl. No.: 15/377,001

(22) Filed: Dec. 13, 2016

(30) Foreign Application Priority Data
Mar. 11, 2016 (KR) 10-2016-0029587

(51) Int. Cl. H02K 21/14; H02K 1/27; H02K 9/06; H02K 1/12

(52) U.S. Cl. CPC H02K 21/14; H02K 1/12; H02K 1/2706; H02K 9/06

(57) ABSTRACT

A brushless direct current (BLDC) motor assembly may include a wheel provided to receive and discharge outside air, and having a coupling region defined therein, a rotor fixedly coupled in the coupling region to be integrated in the coupling region, the wheel being rotated by torque generated according to rotation of the rotor by a magnetic force, and a stator generating a magnetic force by interacting with the rotor, and comprising a stator core, a coil, and an insulator disposed between the stator core and the coil for integral coupling with the stator core and the coil, in which the stator may allow the insulator to be coupled to the rotor after a shaft is fixed to the insulator.

### CROSS-REFERENCE TO RELATED APPLICATION

The present application claims priority to Korean Patent Application No. 10-2016-0029587, filed Mar. 11, 2016, the entire contents of which is incorporated herein for all purposes by this reference.

### BACKGROUND OF THE INVENTION

Field of the Invention

Various aspects of the present invention relate to a brushless direct current (BLDC) motor assembly. More particularly, to a BLDC motor assembly capable of simplifying a manufacturing process and reducing costs.

Description of Related Art

In general, a brushless direct current (BLDC) motor is a motor in which a brush and a commutator are removed from a DC motor and an electronic rectifier is installed therein. The variable speed of the BLDC motor is able to be controlled, and mechanical noise and electrical noise do not occur in the BLDC motor. Accordingly, BLDC motors are widely used in the many fields of industrial equipment, home appliances, transportation vehicles, and the like that require precise rotation control.

In the structure of such a BLDC motor, a poor pressing force between a rotor and a shaft is frequently caused when they are assembled to each other, and the failure of the BLDC motor occurs frequently in the process of balancing the rotor.

That is, the failure of the BLDC motor may occur since the pressing force sensitively acts according to the tolerance between the rotor and the shaft when the shaft is press-fitted into the rotor, and the failure of the BLDC motor may occur due to the fitting depth of the shaft, independently of the problem relating to the pressing force.

For this reason, the BLDC motor may be defective even in a small variation of tolerance of 1/1000 unit when it is manufactured, and the friction noise with bearings may be considerably caused due to flaws on the shaft generated when it is manufactured even though the above defect does not occur. Therefore, it is necessary to accurately manage the manufacturing process.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a brushless direct current (BLDC) motor assembly capable of simplifying a manufacturing process and reducing costs by integrating a rotor with a wheel itself through insert injection molding to eliminate a plurality of balancing processes performed when the rotor is assembled to the wheel.

According to various aspects of the present invention, a BLDC motor assembly may include a wheel provided to receive and discharge outside air, and having a coupling region defined therein, a rotor fixedly coupled in the coupling region so as to be integrated in the coupling region, the wheel being rotated by torque generated according to rotation of the rotor by a magnetic force, and a stator generating a magnetic force by interacting with the rotor, and comprising a stator core, a coil, and an insulator disposed between the stator core and the coil for integral coupling with the stator core and the coil, in which the stator may allow the insulator to be coupled to the rotor after a shaft is fixed to the insulator.

The stator may be formed by fixing the shaft to the insulator through insert injection molding.

The rotor may have a shape corresponding to a shape of the coupling region, and may be fixedly coupled in the coupling region through insert injection molding.

The BLDC motor assembly may further include a bearing to support an upper portion of the shaft, in which the bearing may be fixedly coupled in the coupling region while being vertically spaced apart from the rotor.

The bearing may be formed in the coupling region by insert injection molding in a state in which an installation position of the bearing may be determined in advance such that the shaft inserted through the rotor may be coupled to the bearing in an insertion direction thereof.

It is understood that the term “vehicle” or “vehicular” or other similar terms as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuel derived from resources other than petroleum). As referred to herein, a hybrid vehicle is a vehicle that has two or more sources of power, for example, both gasoline-powered and electric-powered vehicles.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a view schematically illustrating a structure of a brushless direct current (BLDC) motor assembly according to various embodiments of the present invention.

FIG. 2 is a view schematically illustrating a structure of a conventional BLDC motor assembly.

FIG. 3 is a view illustrating the coupling between a rotor and a bearing for the BLDC motor assembly according to various embodiments of the present invention.

FIG. 4 is a view illustrating the shape of the rotor for the BLDC motor assembly according to various embodiments of the present invention.

FIG. 5 is a view illustrating a stator for the BLDC motor assembly according to various embodiments of the present invention.

FIG. 6 is a view illustrating the shape of a flange for the BLDC motor assembly according to various embodiments of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

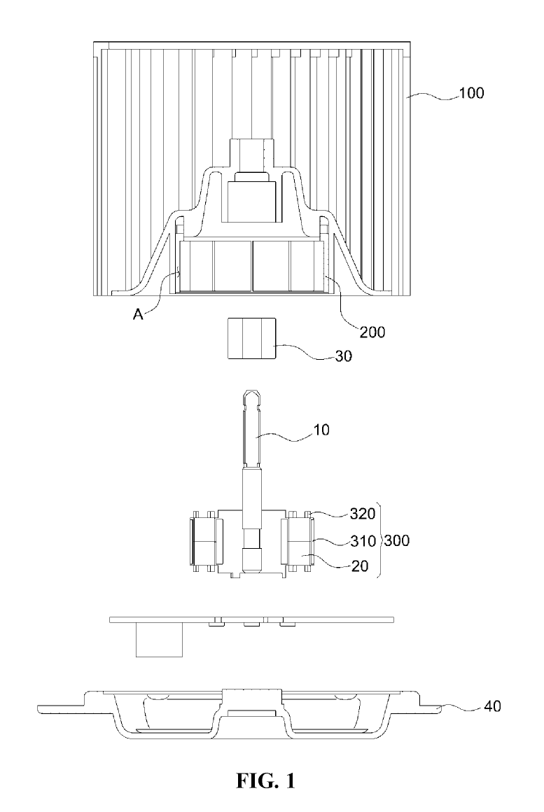

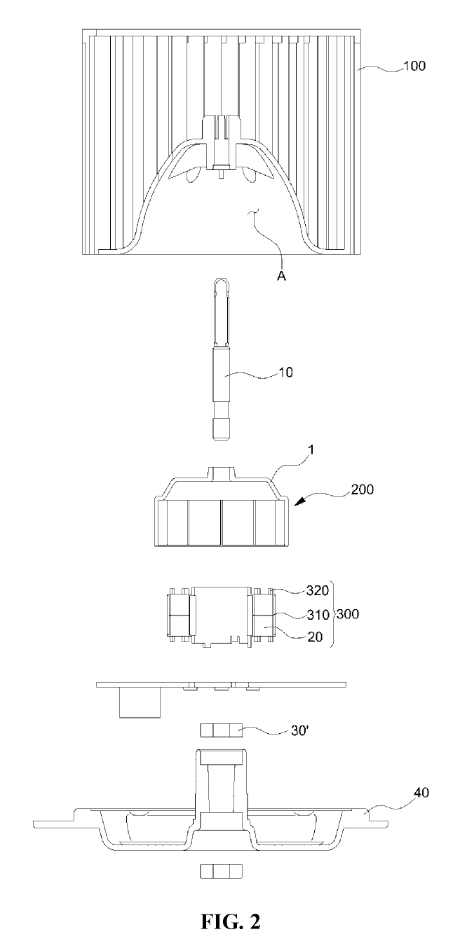

FIG. 1 is a view schematically illustrating a structure of a brushless direct current (BLDC) motor assembly according to various embodiments of the present invention. FIG. 2 is a view schematically illustrating a structure of a conventional BLDC motor assembly.

As illustrated in FIG. 1, the BLDC motor assembly includes a wheel 100, a rotor 200, and a stator 300.

First, the wheel 100 has a fan shape so as to suck and discharge outside air, and has a predetermined-sized coupling region A defined therein.

The rotor 200 is fixedly coupled in the coupling region A so as to be integrated therewith, and is rotated by a magnetic force generated between a magnet provided therein and a coil 320 of the stator 300. Thus, the wheel 100 is rotated by torque generated according to the rotation of the rotor.

Meanwhile, a conventional rotor 200 is installed in a coupling region A after a shaft 10 is press-fitted into a yoke 1 having a magnet, as illustrated in FIG. 2.

Here, it is important that the same pressing force and fitting depth are applied when the shaft 10 is press-fitted into the yoke 1. However, when a BLDC motor is manufactured under the above condition, the failure rate of the BLDC motor may be increased since an error occurs due to a small variation of tolerance of 1/1000 unit.

Noise may be caused due to flaws generated on the surface of the shaft 10 by the friction between the surface of the shaft 10 and the yoke 1 when the shaft 10 is press-fitted into the yoke 1, and it may be difficult to perform balancing in order for the shaft 10 to be vertically press-fitted into the yoke 1.

In addition, the conventional rotor 200 should be coupled such that the yoke 1 is balanced in the coupling region A in the state in which the shaft 10 is vertically press-fitted into the yoke 1 while being balanced therein. For this reason, the failure rate of the motor may be increased while the balancing is performed twice.

Meanwhile, the stator 300 generates a magnetic force by interacting with the rotor 200, and includes a stator core 310, a coil 320, and an insulator 20 which is inserted between the stator core 310 and the coil 320 to be coupled integrally therewith.

The stator 300 according to the various embodiments has a structure in which the insulator 20 and a shaft 10 are coupled integrally therewith, unlike the conventional structure in which the shaft 10 is included in the rotor 200.

As illustrated in FIG. 2, a conventional stator 300 includes upper and lower side portions having different structures since the upper and lower side portions may be inversely assembled due to the structural characteristics thereof. Accordingly, since two molds are required, manufacturing costs may be increased.

On the contrary, the stator 300 according to the various embodiments is coupled to the rotor 200 in which the shaft is integrally fixed to the insulator 20 and the insulator 20 then is fixedly coupled in the coupling region A. Thus, it is possible to reduce costs and resolve the conventional balancing problem relating to the assembly between the shaft 10 and the yoke 1.

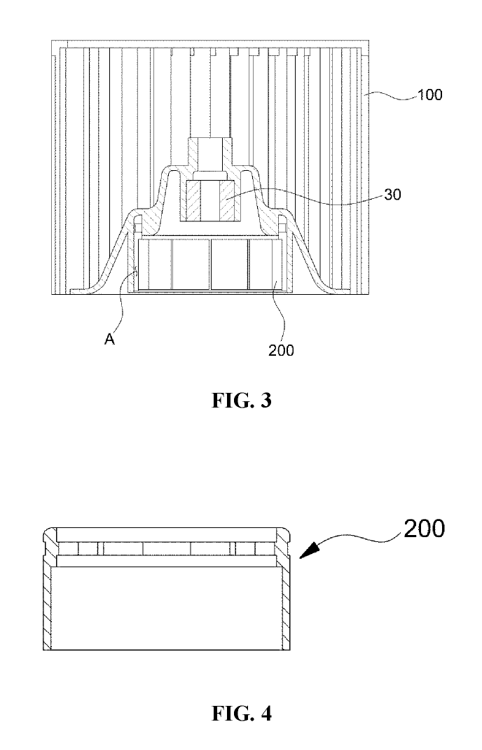

FIG. 3 is a view illustrating the coupling between a rotor and a bearing for the BLDC motor assembly according to various embodiments of the present invention. FIG. 4 is a view illustrating the shape of the rotor for the BLDC motor assembly according to various embodiments of the present invention.

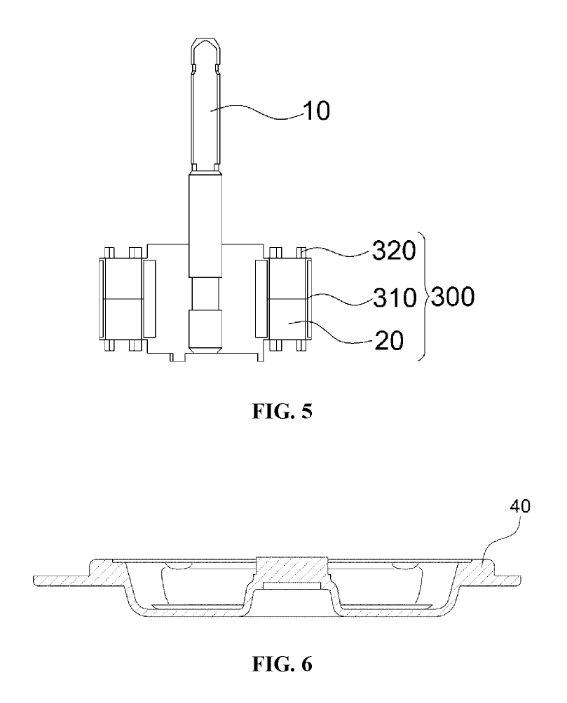

FIG. 5 is a view illustrating the stator for the BLDC motor assembly according to various embodiments of the present invention. FIG. 6 is a view illustrating the shape of a flange for the BLDC motor assembly according to the embodiment of the present invention.

As illustrated in FIG. 3, the rotor 200 has a shape corresponding to the shape of the coupling region A, and is fixedly coupled in the coupling region A through insert injection molding.

Accordingly, the rotor 200 according to various embodiments has a structure that is processed by curling for insert injection molding, as illustrated in FIG. 4, thereby enabling a reduction in weight compared to the conventional rotor 200.

In other words, since the conventional rotor 200 is manufactured using the molds, instead of being integrally coupled in the coupling region A through insert injection molding as in the various embodiments, the manufacturing cost and weight of the rotor 200 are increased and the rotor 200 has a shape for the press-fitting of the shaft 10. Thus, a separate process is additionally required.

The BLDC motor assembly according to various embodiments further includes a bearing 30 which supports the upper portion of the shaft 10. The bearing 30 is fixedly coupled in the coupling region A while being vertically spaced apart from the rotor 200.

That is, the bearing 30 is formed in the coupling region A by insert injection molding in the state in which the installation position of the bearing 30 is determined in advance such that the shaft 10 inserted through the rotor 200 is coupled to the bearing 30 in the insertion direction, as illustrated in FIG. 3. Therefore, the process for balancing the stator 300 may be removed.

In more detail, as illustrated in FIG. 5, when the stator 300, in which the shaft 10 is fixed to the insulator 20 through insert injection molding, is coupled to the rotor 200, the bearing 30 and the rotor 200 are installed in the state in which they are already balanced. Therefore, a separate balancing process may be removed during the coupling of the rotor 200 and the time required for manufacture may be reduced.

Meanwhile, various embodiments of the present invention further include a flange 40 which forms the seating surface of the stator 300 and provides the reference plane of the bearing 30. The flange 40 may have a simple structure compared to the related art, since the stator 300 according to various embodiments allows the shaft 10 and the insulator 20 to be integrally or monolithically formed by insert injection molding.

In other words, a conventional flange 40 needs a separate bush structure in order to install a lower bearing 30′ which supports the lower portion of the shaft 10, as illustrated in FIG. 2. However, this may require a secondary processing cost to manufacture the above structure.

On the contrary, the lower bearing 30′ may be removed from the flange 40 according to various embodiments since the shaft 10 is formed integrally with the insulator 20. Therefore, the flange 40 may have a simple structure for seating the stator 300, and thus the secondary processing cost of the flange 40 may be reduced. In addition, the weight of the BLDC motor assembly may be reduced.

The various embodiments of the present invention can simplify a manufacturing process by integrating the rotor with the wheel itself through insert injection molding to eliminate a plurality of balancing processes performed when the rotor is assembled to the wheel.

In the various embodiments of the present invention, since the stator is formed by fixing the shaft to the insulator through insert injection molding, it is possible to prevent noise from being caused due to the conventional problems relating to the pressing force, the fitting depth, and the flaws on the surface of the shaft when the shaft is press-fitted into the rotor.

In addition, since the bearing is assembled in the wheel instead of being mounted to the inner diameter portion of the flange, the separate bush structure for seating the bearing and the stator can be removed. Consequently, it is possible to reduce overall weight and costs.

As is apparent from the above description, the various embodiments of the present invention can simplify a manufacturing process by integrating a rotor with a wheel itself through insert injection molding to eliminate a plurality of balancing processes performed when the rotor is assembled to the wheel.

In the various embodiments of the present invention, since a stator is formed by fixing a shaft to an insulator through insert injection molding, it is possible to prevent noise from being caused due to conventional problems relating to a pressing force, a fitting depth, and flaws on the surface of a shaft when the shaft is press-fitted into a rotor.

In addition, since a bearing is assembled in the wheel instead of being mounted to the inner diameter portion of a flange, a separate bush structure for seating the bearing and the stator can be removed. Consequently, it is possible to reduce overall weight and costs.

For convenience in explanation and accurate definition in the appended claims, the terms “upper” or “lower”, “inner” or “outer” and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A brushless direct current (BLDC) motor assembly comprising:
a wheel provided to receive and discharge outside air, and having a coupling region defined therein;
a rotor fixedly coupled in the coupling region to be integrated in the coupling region, the wheel being rotated by torque generated according to rotation of the rotor by a magnetic force; and
a stator generating a magnetic force by interacting with the rotor, and comprising a stator core, a coil, and an insulator disposed between the stator core and the coil for integral coupling with the stator core and the coil,
wherein the stator allows the insulator to be coupled to the rotor after a shaft is fixed to the insulator.

2. The BLDC motor assembly of claim 1, wherein the stator is formed by fixing the shaft to the insulator through insert injection molding.

3. The BLDC motor assembly of claim 1, wherein the rotor has a shape corresponding to a shape of the coupling region, and is fixedly coupled in the coupling region through insert injection molding.

4. The BLDC motor assembly of claim 1, further comprising a bearing to support an upper portion of the shaft, wherein the bearing is fixedly coupled in the coupling region while being vertically spaced apart from the rotor.

5. The BLDC motor assembly of claim 4, wherein the bearing is formed in the coupling region by insert injection molding in a state in which an installation position of the bearing is determined in advance such that the shaft inserted through the rotor is coupled to the bearing in an insertion direction thereof.
